(19) United States
(12) Patent Application Publication
(10) Pub. No.: US 2024/0104553 A1
(43) Pub. Date: Mar. 28, 2024

(54) Content Containerization, Distribution and Administration Systems, Methods, and Computer Products

(71) Applicant: Formless, Inc., Wilmington, DE (US)

(72) Inventor: BRANDON TORY THORPE, Cambridge, MA (US)

(73) Assignee: Formless, Inc., Wilmington, DE (US)

(21) Appl. No.: 17/951,733

(22) Filed: Sep. 23, 2022

(51) Int. Cl. G06Q 20/36; G06F 21/60; H04L 67/02

(52) U.S. Cl. CPC G06Q 20/3674; G06F 21/602; H04L 67/02

(57) ABSTRACT

A method, system, and non-transient storage medium with instructions that can be used to implement a method to containerize content into a self-administered program that interoperates with an unbounded number of vendors on the Internet. Analogous to a digital vending machine, this enables content to vend on behalf of the creator or content owner, on any property, rather than a singular property owned by the creator or a single vendor. A container includes the access policy implementation and distributes a single machine interface (e.g. the blockchain address) to an unbounded number of target properties on which the machine may vend in perpetuity using the access policy specified by the creator.

This disclosure generally relates to content management systems, and policy systems for management of rights for access to and use of content, typically copies of creative works.

The computer programs disclosed in this patent application are subject to copyright protection under the copyright laws of the United States and of other countries. As of the first effective filing date of the present application, this material is protected as published material, and to the extent not already subject to protection for published material, as unpublished material. However, permission to copy the computer programs is hereby granted to the extent that the owner of the copyright rights has no objection to the facsimile reproduction by anyone of the patent document or patent disclosure, as it appears in the United States Patent and Trademark Office patent file or records, but otherwise reserves all copyright rights whatsoever.

### BACKGROUND

The concepts of “content” and “creative work” are often used interchangeably when referring to creative works. However, there are important distinctions that should be kept in mind.

When creative works become fixed in a tangible medium, the creators become imbued with a number of legal rights including the rights of: reproduction; public display; public performance; distribution by sale or other transfer of ownership or by rental, lending, or leasing; and transmission, depending upon the type of work involved. In most cases, in the exercise of those rights, a physical version of the work that can be transmitted or itself reproduced is made. This physical version of a work is content, and in the digital age content is digital data symbolizing a creative work.

While creators initially own all of the rights in a creative work, those rights can be transferred above so that the exercise of one or more of the rights can be undertaken by a transferee such as an assignee or licensee. Further, content embodying the creative work can be distributed without affecting the ownership of the rights in the corresponding creative work, as mentioned above. Thus, ownership of content is distinct from ownership of the intellectual property rights to the corresponding creative work. In this way content, e.g., in the form of copies of artwork, images, songs, etc. can be distributed on a blockchain, without transfer of ownership rights to the underlying creative work.

Content typically is served to consumers through a number of channels, most often controlled by vendors, or alternatively controlled by the owner or licensee through a singular channel (e.g. on their own website or their own hardware). If the content owner, or licensee chooses to distribute content through their own medium, access to that content is restricted to that channel and therefore distribution is severely limited. Alternatively, third party mediums may be hardware products such as Sony Corporation's Walkman®, or software products/platforms such as Spotify® and YouTube®. The relationship between the creator/owner/licensee and consumer is intermediated by the vendor since the vendor hardware or platform controls the code which implements the access policy (price, access time, ability to sub-license) of the content. Content owners or licensees must adhere to this policy or find another vendor to distribute the content.

The challenge addressed herein is that there is no method by which a creative work owner or licensee can associate the access policy implementation with the distributed content in a way such that a single access policy can be self-administered by the content itself independently of the vendor hardware or software. Digital rights management (DRM) software/solutions do not solve this as DRM is by definition software and/or hardware created and controlled by a vendor (or group of vendors) and not by each individual creative work owner or licensee, which in many cases is the creator.

### SUMMARY

The present disclosure provides one or more inventions concerning methods, systems, and computer products for distributing content via a computer network, e.g., the Internet, using a standalone program rather than merely a data file to be interpreted by a vendor program. This allows self-administered access to content, and distribution of the content or access to the content onto an unbounded number of third party platforms while continuing to perform that self-administration (including, e.g. royalty accounting and price control). The containerization and distribution scheme involves inverting the conceptual model of a piece of content such that all programmatic dependencies for serving the content are content deployer controlled (rather than vendor controlled). The process preferably is as follows:
a. Deploy content to a storage location, for example, Cloud storage or the Interplanetary File System (IPFS). The content data is encrypted at rest.
b. Deploy a per-content (or per-N-content where N is the size of some collection of content) distribution program microservice that can read the storage location and stream the bytes of the content at high performance based on some program state that is stored on a blockchain. The program state represents the presence of a temporal license grant issued to a blockchain identity of a consumer. The bytes streamed to the consumer are conditionally rendered, e.g. if a license is not granted, preview content bytes may be streamed. Otherwise, the actual bytes are streamed.
c. Compile a program (e.g. an Ethereum® Virtual Machine (EVM) program) which is a smart contract, that is able to write license grant information to contract storage at transaction time. The EVM that is used to execute the smart contract creates a virtual environment as a local instance on every Ethereum® node for handling smart contracts. Since all instances of the EVM operate from the same initial state and produce the same final state by consensus, the system of nodes as a whole operates like a single computer.

Analogous to a digital vending machine, this arrangement and process enables content to vend on behalf of the creator or content owner, on any property, rather than a singular property owned by the creator or a single vendor. A container includes the smart contract program and the access policy implementation and distributes a single machine interface (e.g. the blockchain address) to an unbounded number of target properties on which the machine may vend in perpetuity using the access policy specified by the creator or content owner.

Note that Ethereum® is an example blockchain but the disclosed invention is not limited to Ethereum®, for example, Polygon™ transactions also qualify as a transactional source of truth which can be read by the distribution microservice. In addition to persisting the license grant, this program directs funds from the transaction to the owner of the program (the program is the smart contract). The contract allows the owner to perform administrative operations such as withdrawals or updates to the storage locations. The contract implements a standard interface such as the Ethereum® Request for Comment Number 721 (ERC-721) which many vendors may support. Within the interface, the distribution service URI which conditionally renders content based on the contract state is exposed through a standard function exposed in the contract interface.

This is made possible by taking advantage of ERC-721 token metadata standard including the use of the uniform resource indicators (URIs) in the metadata. This disclosure introduces a layer which uses this metadata interface as a transaction-based interlock between content owner and consumer at every observable entry point of the content. As a result, the following code can be executed from any server: “Check if entity N paid what the creative work owner has asked for”, and “provide access to the content.” This code requires very limited stateful behavior to have a massive impact: confirming financial transactions and updating state variables readable by decentralized content delivery (distribution) networks.

The output of the system described above is a standalone content-related container that includes an access policy that can be executed by any vendor with access to a blockchain. The result of executing the policy in adherence with the creator's specified terms (e.g., paying the specified price), is that decrypted content data bytes are streamed through the contract's standard interface to the consumer. One reason this is possible is that the code executes on decentralized infrastructure rather than on vendor-controlled hardware. In other words, it would not be possible to ship custom access policy code to Spotify®, YouTube®, and Apple Music® servers for server-side execution since each has a different system architecture and system administration policy. In these cases the creator or the creator's assignee or licensee is bound to the per-vendor access policies specified in each of the vendors respective Terms-Of-Service (ToS), where the ToS are codified and executed within the vendor controlled environment. There is no runtime environment in which a single set of access policy instructions codified by the creator or the creator's assignee or licensee could be allowed to execute in a traditional distribution model.

However, by executing the policy code on a blockchain, the vendor can invoke the content container program safely and comply with creator-controlled access terms, codified in the content container contract. This migration of access policy code from a vendor-controlled execution environment into a creator-controlled execution environment can be called “access inversion”—the content does not depend on vendor access policies (such as the price per stream), rather the inverse is true.

The concept of a pay-for-access (PFA) smart contract is especially helpful. This is akin to a rental or leasing contract. The price per access (e.g. a view or listen) can be set to zero as it is today for nearly all non-fungible tokens (NFTs). However, it can also be set to a non-zero value. This means that content will exist which cannot be observed or accessed until a micro-payment is recorded on the blockchain. It is important to note that this disclosure is distinct from gating access to content based on token ownership, e.g. it does not require the licensee or consumer to own any token in exchange for access—rather it is based on microtransaction records stored in the state of the PFA smart contract. In order to enable high-volume transactions at low cost, the present principles are best implemented on scaling solutions such as the Polygon® Proof-of-Stake (PoS) sidechain, however they will support implementation on additional chains, and new Etherium® Virtual Machine (EVM) compatible zero knowledge (ZK) rollups as they launch.

Unlockable PFA experiences at scale can create immense impact for content owners/creators. At high volume, micro payment transactions on observables are much more sustainable than trying to sell a single NFT for a high price to one buyer. Rallying a community to establish value around an NFT can be a stressful endeavor for artists, and an alternative model is to charge a creator-specified price for the ability to experience the art. Putting more content monetization options (PFA, pricing, and sponsor revenue) into the hands of content owners/creators, enables them to choose which combination of models work best for their business.

The following terminology is employed herein:

“Accessing” in the context of “accessing content” or “accessing the content” means gaining the ability to experience the work corresponding to or embodied in the content. This is time bound and the time is specified by the creative work owner.

“API” means an application programming interface. APIs are code which enable applications to exchange data and functionality.

“Blockchain” means any sufficiently decentralized network of processors or computers which provides the ability to transact, and to execute code, with consensus on the resulting world state transitions by a set of decentralized actors.

“Code” means computer processor executable instructions.

“Container” means a jointly compiled smart contract and application programming interface that together control access to content and contract storage associated with the smart contract.

“Content” means digital data symbolizing a creative work, and which is in an accessible digital file format such as WAV, MOV, MPEG, MP3, MP4, ALAC, FLAC, EPUB, JPEG, GLB, 3MF, PNG, TIFF, etc.

“Content Container” means a container and distribution service program which backs the container to conditionally render content to a user or vendor application based on a state of the container smart contract.

“Content data” means and comprises the content, one or more portions of the content, e.g., snippet(s), or preview(s), and/or metadata of the content.

“Content deployer” means a natural person who or juridical entity which deploys content together with an access policy for or criteria for accessing the deployed content. A Content Deployer preferably is the creator, assignee, licensee, or other controller of rights to the creative work which is embodied in the content.

“Contract owner” means the natural person who or juridical entity which controls a smart contract.

“Contract storage” means processor readable data storage medium for storing data establishing a state of an associated smart contract.

“Core content” means the content embodying the creative work when it is deployed with other content data.

“Distribution microservice” means processor executable instructions or code that read container contract storage data and render content controlled by the container directly or indirectly to a user application when permitted by the container.

“Experience the work” means to view, read, listen to or otherwise use the corresponding content, dependent upon the type of work being experienced.

“IP” means Internet Protocol.

“Processor” means one or more devices that process or execute programming instructions or code to effect a function dictated by the instructions or code.

“Smart Contract” means an immutable computer program which verifies and executes its terms upon the occurrence of predetermined events. A smart contract can run deterministically in the context of a decentralized world computer. The ownership of a smart contract is mutable and the address(es) of the contract owner(s) are mutable for that purpose.

In an embodiment, non-transient processor readable storage medium contains processor executable instructions that when executed by the processor cause the processor to:
read a contract program storage to determine a state of a smart contract; and
render bytes of content to a user application when the state of the smart contract permits access to the content to the user.

In an embodiment, the instructions cause the processor to render previously selected bytes of the content to the user application when the state of the smart contract does not permit access to all of the content to the user.

In an embodiment, the processor executable instructions cause the processor to render the content to an endpoint having an IP address using the HTTPS protocol.

In an embodiment, the processor executable instructions cause the processor to conditionally stream the content to an endpoint having an IP address using the HTTPS protocol.

In an embodiment, the non-transient processor readable storage is not located on a block chain.

In an embodiment, the processor executable instructions cause the processor to render the content to an address provided by a token URI function or its equivalent.

In an embodiment, the programming instructions comprise a distribution microservice.

In an embodiment, the programming instructions are mutable.

In an embodiment, the programming instructions cause the processor to decrypt the bytes of the content.

In an embodiment, a non-transient processor readable storage medium of a blockchain network contains processor executable instructions that when executed by the processor cause the processor to:
control access to content using a smart contract program of a smart contract by establishing terms for access to the content and determine if a user application or user, within a given application has complied with the terms;
store data indicating a state a smart contract; and
communicate with a distribution microservice via an API,
   wherein,
the programming instructions comprise a container.

In an embodiment, the container is addressable by an identifier of the blockchain and an address on the blockchain.

In an embodiment, the programming instructions cause the API to communicate with a user application and the distribution microservice and to render bytes of the content to the user application.

In an embodiment, the executable instructions initialize the API with data concerning:
a token URI function;
a price per access to the content; and
a total time to live for access to the content.

In an embodiment, the executable instructions enable the distribution microservice to call for information as to when access to the content was granted and information as to when a license was granted to access the content.

In an embodiment, the executable instructions enable a user application to:
obtain information as to a price to access the content;
obtain information as to a price for a license to use the content; and
retrieve an address to which the content is to be rendered.

In an embodiment, the executable instructions enable the API to render the bytes of the content to a user application via a token URI function.

In an embodiment, the contract program includes data establishing a price to access the content and a total time to live in which access to the content is open.

In an embodiment, the contract program includes data establishing a price to access the content and a total time to live in which access to the content is open.

In an embodiment, a content distribution systems comprises:
a blockchain network;
a non-blockchain network;
a container stored on the blockchain network, the container being addressable by a blockchain network identifier and a blockchain address;
content stored on network addressable processor readable storage; and
a distribution microservice stored on a non-blockchain network,
   wherein,
the container includes an API that contains an address of the distribution microservice,
the container includes an address for the content, and
the API is configured to communicate with the distribution microservice and a computer application to which the content is to be rendered.

In an embodiment, the computer application is an intermediary application that can communicate between the API and a user application.

In an embodiment, the computer application is a user application.

In an embodiment, the API is initialized by the smart contract program with:
a token URI function;
a price per access to the content; and
a total time to live for access to the content.

In an embodiment, the API is configured to provide:
information as to a price to access the content;
information as to a price for a license to use the content; and
an address to which the content is to be rendered.

In an embodiment, the API renders the bytes of the data using the token URI function or its equivalent.

In an embodiment, the distribution microservice confirms an identity of the user using a signed message which uses a private key associated with user.

In an embodiment, a method comprises:
generating an access policy for content to be distributed over a computer network;
providing the access policy and content to a deployment service which is configured to provide (a) the content to a network accessible storage location, (b) the access policy to a complier which is configured to compile the access policy and an application programming interface into a container including a smart contract program and the application programming interface, and (c) a distribution microservice configured to interact with the container and determine a state of the smart contract program and render bytes of the content in accordance with the state of the smart contract program.

In an embodiment, the content is encrypted while stored.

In an embodiment, the distribution microservice decrypts the bytes of the content when rendering the bytes.

In an embodiment, the method also comprises storing the container on a blockchain network.

In an embodiment, the method also comprises storing the distribution microservice on a non-blockchain network.

In an embodiment, the container is accessed using a blockchain network identifier and an address on the blockchain by the distribution microservice and a user application.

In an embodiment, the container includes contract program storage with data indicating the state of the smart contract program.

Other systems, methods, features, and advantages of the one or more disclosed inventions will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the system disclosed herein, together with the description, explain the advantages and principles of the disclosed system. In the drawings:

FIG. 1 illustrates in a flow diagram how content can be containerized and distributed in accordance with principles disclosed herein.

FIG. 2 illustrates a relationship between the parts of the container after distribution in accordance with principles disclosed herein.

FIG. 3 illustrates a container API (e.g., smart contract interface) in accordance with principles disclosed herein.

FIG. 4 illustrates a relationship between an interacting user and the containerized content in accordance with principles disclosed herein.

FIGS. 5a and 5b illustrate a comparison between historic DRM technology and containerized content management in accordance with principles disclosed herein.

### DETAILED DESCRIPTION

Reference will now be made in detail to one or more implementations or embodiments consistent with the principles disclosed herein with reference to the accompanying drawings.

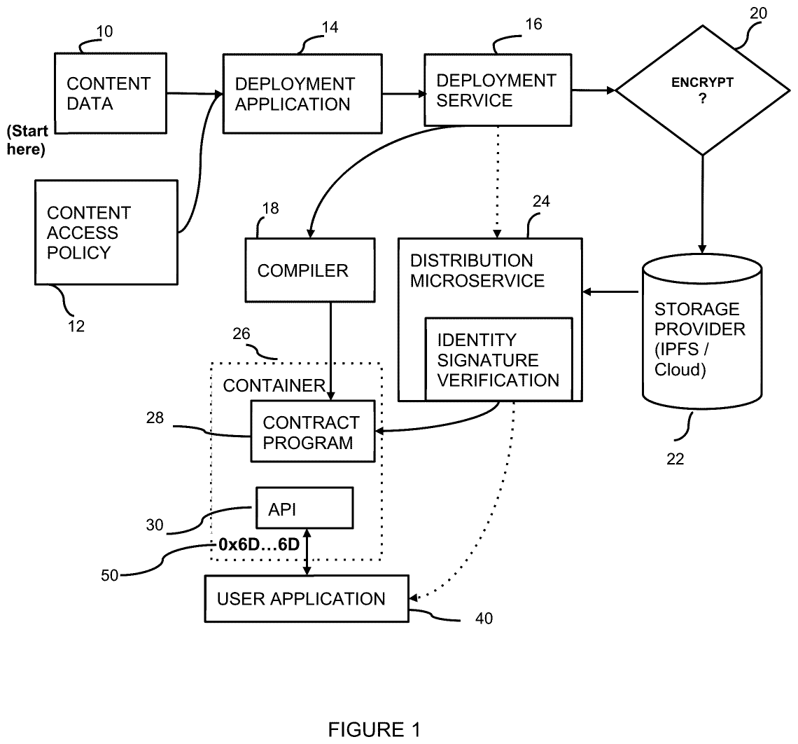

Referring to FIG. 1, in an embodiment, content data 10 and a content access policy 12 (established by the content deployer) are combined into a deployment application 14. The deployment application 14 is then provided or deployed to a deployment service 16 which splits the deployment application 14 into two parts. A first part comprises a data streaming API and the access policy 14 which are deployed to a compiler 18 which codifies or compiles the content access policy 12 and the data streaming API 14 into a container 26. The container 26 is a smart contract which is executable on a blockchain such as Ethereum. The core content is in an accessible format such as WAV, MOV, MPEG, MP3, MP4, ALAC, FLAC, EPUB, JPEG, GLB, 3MF, PNG, TIFF, etc. (but encrypted when stored as described next). The container 26 is deployed to a blockchain.

Ethereum® is a decentralized, open-source blockchain with smart contract functionality. The Ethereum® blockchain is a permissionless, non-hierarchical network of computers (nodes) that build and come to a consensus on an ever-growing series of “blocks”, or batches of transactions. Each block contains an identifier of the chain that must precede it if the block is to be considered valid. Whenever a node adds a block to its chain, it executes the transactions in the block in the order they are listed, thereby altering cryptocurrency balances (in Ether (ETH)) and other storage values of accounts.

At the same time that the container 26 is deployed, the deployment service 16 deploys the content data 10 to a storage provider or hosting service 22 which can be, for example, a cloud service or an IPFS service. Preferably, content snippet(s) and/or preview(s) and/or metadata is(are) not encrypted, but the core content is encrypted by an encryption service or application 20 at storage time.

The container 26 thus has a contract program or code 28 which implements the access policy 12 and a container API 30. The container API 30 of the container 26 controls which distribution microservice or program 24 backs the content 12. It is mutable by the contract owner, preferably the content deployer. The container API 30 serves content to a user application 40 with a standard function token URI. However, the actual content streamed is conditional based on a contract state, which is verified by the distribution microservice 24 at streaming time.

The distribution microservice or program 24 is optionally spawned for each piece of content or per-N-contents where N is the size of some collection of content, by the deployment service 16. This backs the container 26 and is what conditionally renders the content or other content data to the user application 40 based on contract state. This service 24 can be spawned by the content deployer (e.g. in this diagram it is provided as a service). The code of the microservice 24 may run on a platform as a process in memory, which is a non-transient (also known as non-transitory) computer or processor readable medium which stores programming code.

The content of the content data 10, may become accessible in plaintext (i.e., unencrypted) in random access memory, which is available to a consumer or their application 40 at runtime. The core content may be transmitted over an encrypted channel, using for example, a Secure Sockets Layer (SSL) and then decrypted via the API 30. The container program 28 logic executes on ownerless infrastructure on a blockchain, imposing no additional technical requirement on the distributee. The implication of this method is that all content administration is alleviated from the host and delegated to the owner of the contract program 28, preferably the content deployer, which preferably is the creator, and assignee or licensee.

The code of the microservice 24, which may be interpreted by a runtime machine, e.g. Node.js which is a JavaScript® runtime built on Chrome's V8 JavaScript engine, and interacts with the access policy code 12 complied into the container 26 and the content data 10 to decrypt and serve the core content of content data 10. The code of the microservice 24 can also later remove the decrypted core content after time-to-live (TTL) is reached, with TTL established by the access policy code 12.

Applications 40 and users actuate the stored content data or core content by executing the access policy in the container contract program 28. This may include the use or the user application 40 paying the container 26 directly per the access policy. The container 26 can receive digital currency directly since it executes on a blockchain.

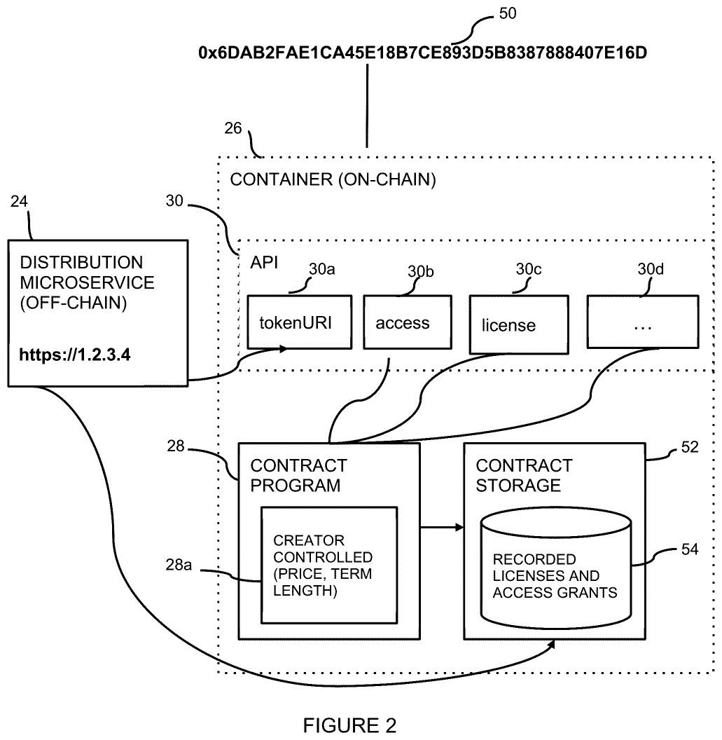

In FIG. 2, components of the container 26 are detailed as is the interaction with the distribution microservice 24. As shown, the container 26 includes the contract program 28, which includes terms information 28a setting forth the creator's or content deployer's price and term (length of life). The contract program 28 is in communication with contract storage 52 which is used to store or record information regarding licenses and grants of access to contents.

Also illustrated in block form is the container API 30, which includes code for the endpoint of the content or core content via the function token URI 30a, access function 30b, license 30c, and another other optional functions 30d.

As illustrated in FIG. 2, the distribution microservice 24 which backs the container 26 reads container contract storage 52 to determine whether, for a given uniquely identified user/user application 40 or vendor, access (or a license) has been awarded. The microservice 24 conditionally renders a byte stream of the stored content 10, e.g., the core content, over HTTPS, which is an endpoint made available by the contract token URI function. The token URI function is a standard ERC-721 interface function which is widely adopted and known in other applications. The IP address of the microservice 24 is not distributed. Knowledge of the container 26 address alone is sufficient, as the address of the distribution microservice 24 is mutable within the contract terms 28a of the contract program 28.

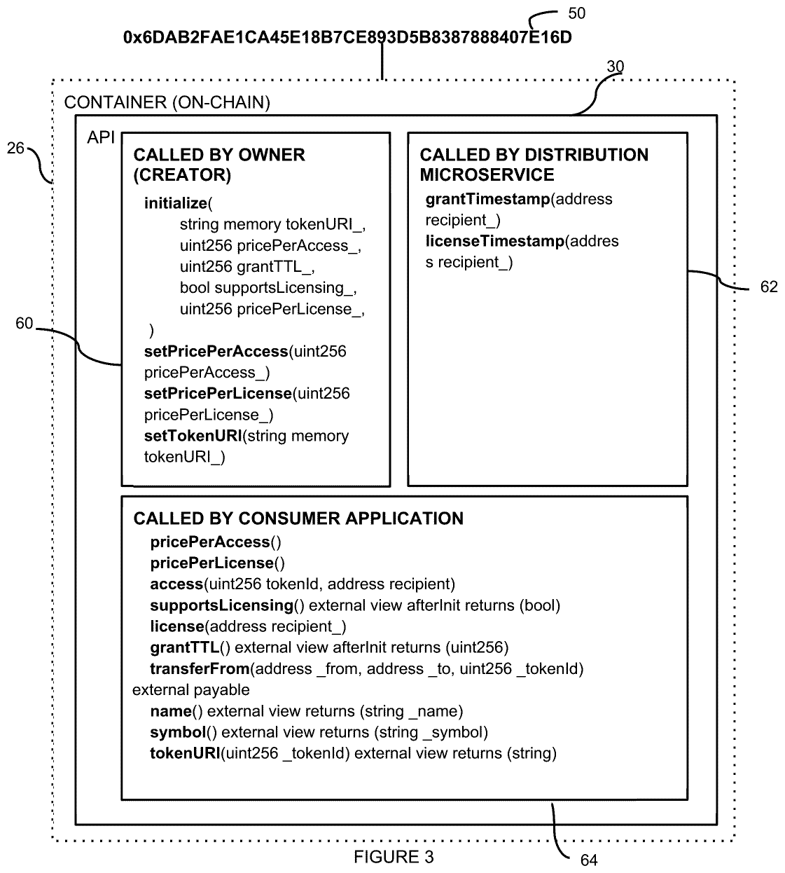

In FIG. 3, the container API 30 is illustrated in more detail. As illustrated, the blockchain address 50 is associated with the container 26. The container API 30 includes at least three sets of callable functions. First, there is a content controller (preferably a creator) set of callable functions 60. Second there is a microservice 24 set of callable functions 62. Third, there is a consumer application 40 set of callable functions 64.

Smart contract API callers implicitly supply their unique identity in the form of a 160-bit blockchain address 50. This identity is proven by the distribution microservice 24 (FIG. 2) using a signed message which uses a private key associated with the identity 50. This signature is included in HTTPS requests to the token URI 30a (FIG. 2) exposed by the contract program 28 (FIG. 2). Thus, preferably, a 160-bit blockchain address 50, along with a blockchain identifier, fully qualifies the stored content 10 (FIG. 1) and it's access policy. This address is that of the container 26 (FIG. 1) that is distributed. Since the container 26 (FIG. 1) implements the ERC-721 interface (among other interfaces) the container 26 (FIG. 1) itself may be purchased and sold to new owners. Revenues (e.g. royalties) accrued as a result of the access policy 12 (FIG. 1) are forwarded to the contract owner's address stored in the contract program 28 (FIG. 1).

The container API 30 restricts access to certain functions based on the identity of a user invoking the function from a given user application, 40 (FIG. 1).

The contract owner call function 60 initializes the following the parameters, token URI, price per access, the time to live (TTL), whether a license can be granted using the following code:

```
Initialize{
  string memory tokenURI_,
  uint256 pricePerAccess_,
  uint256 grantTTL_,
  bool supportsLicensing_,
  uint256 pricePerLicense_,
}
setPricePerAccess(uint256 pricePerAccess_)
setPricePerLicense(uint256 pricePerLicense_)
setTokenURI(string memory tokenURI_)
```

The code called by the distribution microservice 24 includes:

grantTimestamp(address recipient_)
license Timestamp(address recipient_)

The consumer application interacts with the API 30 by invoking the following functions to understand the terms for use of the content and transacting with the contract container 26:

pricePerAccess( )
pricePerLicense( )
access(uint256 tokenld, address recipient)
supportsLicensing( ) external view afterInit returns (bool)
license(address recipient_)
grantTTL( ) external view afterInit returns (uint256)
transferFrom(address_from, address _to, uint256 _tokenld) external payable
name( ) external view returns (string _name)
symbol( ) external view returns (string _symbol)
tokenURI(uint256 _tokenld) external view returns (string)

As can be appreciated, with a container 26 configured with this API 30 and with the microservice 24 which backs the container 26, each content is self-contained and self-administered independent of the application layer. That is to say, the container 26 and the microservice provide a content container. Core content of the content data 10 is uniquely and universally identified using the blockchain address of the container program 28, along with the blockchain identifier. For example, the identifying information can include a 2-tuple, e.g. a finite ordered list of two elements, where the elements comprise the blockchain address and the numeral which corresponds with the identifier of the blockchain. The Ethereum blockchain has identifier 1 while the Polygon blockchain has identifier 137.

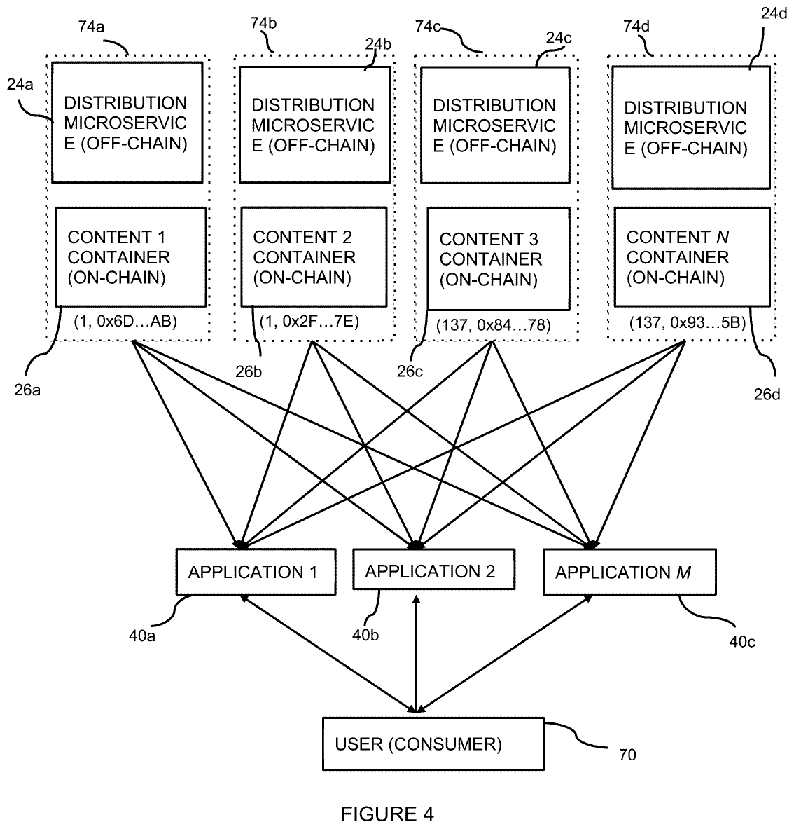

In FIG. 4, this is shown diagramatically, where the spatial relationship between an interacting user 70 and the containerized content, through any capable application interface is illustrated.

As can be seen in FIG. 4, a user/consumer 70 interacts with one or more vendor applications, which in this exemplary embodiment are three in number, 40a-40c. In turn, each vendor application can interact with any number of content containers, which in this exemplary embodiment are four in number, 74a-74d. Each content container includes its respective off-blockchain distribution microservice and on-blockchain container. Content containers 74a and 74b use the Ethereum® identifier 1, while content containers 74c and 74d use the Polygon™ blockchain identifier 137, in addition to the blockchain addresses of the containers.

With this structure, an unbounded number of vendor applications can have legal access to an unbounded number of the distributed containers, which in this exemplary embodiment are four in number, 26a-26d. All are able to execute the access policy which resides on a blockchain. All are able to route the resulting content stream to any user, and route royalty revenues to the contract owner.

In its final form, a container such as the container 26 (FIG. 1) comprises a smart contract 28 (FIG. 1) that may be implemented in, e.g., Solidity. The contract exposes the API 30 (FIG. 1) that enables the contract owner to administer certain policy configurations, as well as enabling consumers and vendors to access (or sub-license) the decrypted content data (core content) by adhering to said policy (for example by paying the contract for access using a microtransaction). The following code, replete with explanatory comments, is an implementation of a pay-for-access (PFA) contract which is a program linked to both the content data (e.g. via standard ERC-721 token URI function) and the access policy (e.g. via access and license functions).

As can be appreciated, the content data (and specifically the core content) is not itself physically persisted onto the blockchain but rather that access to the content data is exposed through a contract function. The process by which the content data (core content, snippet(s), preview(s), and/or metadata) is packaged with a container smart contract and associated distribution service begins with the deployment application 14 that accepts the content access policy 14 from the content deployer and codifies or complies that information to send to the deployment service 16. The deployment service 16 can also run within a frontend application, but in one embodiment (e.g. a preferred embodiment), can be run in a server that can handle many contract deployments. For each created container 26, the deployment service 16 will spawn a distribution microservice 24 as well as compile the smart contract program 28. Below is code, replete with explanatory comments, which can send the configuration of the initial access policy 12 to the deployment service 16, e.g. it enables the content deployer to specify, e.g., the asset title, data file, associated royalty splits, target blockchain, price per access, owner, and access grant time TTL (among other attributes):

```
function deployAssetToNetwork(
  provider,
  totalDeploymentCostWei,
  assetTitle,
  creatorName,
  contentFile,
  priceUSD,
  gas ToCompleteTx,
  gasPrice ToCompleteTxGwei,
  primaryOwnerAddress,
  enableRoyaltySplits,
  royaltySplitRows,
  assetGrantTTLSeconds,
  blockchainOption,
  setDeploymentStatus,
  setShowLoadingIndicator,
  setDeployedContractURI,
  setDeployedContractAddress,
  signature,
  primaryContentStorageData,
  enableAppleAndGooglePay,
  customAudioPreviewURI = null,
  customVideoPreviewURI = null,
  customArtworkURI = null
) {
  const deploymentSuccessFn = (result) => {
    setShowLoadingIndicator(false);
    setDeploymentStatus(
      “Success. Asset deployed to blockchain (Tap link to view):”
    );
    setDeployedContractURI(
      makeShareAssetURI(result.contract_address, blockchainOption)
    );
    setDeployedContractAddress(
      makeFormattedAddress(result.contract_address)
    );
  };
  const deploymentFailureFn = (error, custom_error_msg) => {
    if (!custom_error_msg) {
      custom_error_msg = “Unable to deploy asset”;
    }
    setShowLoadingIndicator(false);
    setDeploymentStatus(
      ‘${custom_error_msg}: ${formatErrorMessage(error)}.’
    );
  };
  // Start showing progress
  setShowLoadingIndicator(true);
  payContractDeploymentFee(
    provider /* provider */,
    DEPLOYMENT_SERVICE_ACCOUNT_ADDRESS,
    totalDeploymentCostWei /* amountWei */,
    blockchainOptionToNetworkID(blockchainOption) /* networkId */,
    signature /* signature */,
    // signingBeginCallback: Callback called on begin transaction signature
    ( ) => {
      setDeploymentStatus(“Signing transaction...”);
    },
    // loadingBeginCallback: Callback called on begin transaction loading
    ( ) => {
      setDeploymentStatus(“Sending transaction to the network...”);
    },
    // Handle success
    (receipt) => {
      if (enableRoyaltySplits) {
        setDeploymentStatus(“Deploying royalty split contract...”);
        // Deploy asset contract with primary owner equal to the
        // address of the split contract
        deploySplitContract(
          primaryOwnerAddress,
          royaltySplitRows,
          gas ToCompleteTx,
          gasPriceToCompleteTxGwei,
          blockchainOptionToRPCEndpoint(blockchainOption),
          blockchainOptionToNetworkID(blockchainOption),
          signature
        )
          .then((splitContractAddress) => {
            deployAssetContract(
              assetTitle /* assetTitle */,
              creatorName /* creatorName */,
              contentFile /* contentFile */,
              splitContractAddress /* primaryOwnerAddress (owner = split) */,
              primaryOwnerAddress /* creatorAddress (creator = primary) */,
              priceUSD /* priceUSD */,
              gasToCompleteTx /* gas ToCompleteTx */,
              gasPriceToCompleteTxGwei /* gasPriceToCompleteTxGwei */,
              assetGrantTTLSeconds /* assetGrantTTLSeconds */,
              blockchainOption /* blockchainOption */,
              setDeploymentStatus /* setDeploymentStatus */,
              signature /* signature */,
              primaryContentStorageData /* Storage upload data */,
              enableAppleAndGooglePay /* enableAppleAndGooglePay */,
              customAudioPreviewURI /* customAudioPreviewURI */,
              custom VideoPreviewURI /* custom VideoPreviewURI */,
              customArtworkURI /* customArtworkURI */
            )
              .then((result) => {
                // On deployment success
                deploymentSuccessFn(result);
              })
              .catch((error) => {
                deploymentFailureFn(
                  error,
                  “Split contract asset deployment failed”
                );
              });
          })
          .catch((error) => {
            deploymentFailureFn(
              error,
              “Unable to deploy split contract”
            );
          });
      } else {
        // Deploy asset contract with primary owner equal to the
        // address of the individual uploader.
        deployAssetContract(
          assetTitle /* assetTitle */,
          creatorName /* creatorName */,
          contentFile /* contentFile */,
          primaryOwnerAddress /* primaryOwnerAddress */,
          primaryOwnerAddress /* creatorAddress */,
          priceUSD /* priceUSD */,
          gasToCompleteTx /* gas ToCompleteTx */,
          gasPrice ToCompleteTxGwei /* gasPriceToCompleteTxGwei */,
          assetGrantTTLSeconds /* assetGrantTTLSeconds */,
          blockchainOption /* blockchainOption */,
          setDeploymentStatus /* setDeploymentStatus */,
          signature /* signature */,
          primaryContentStorageData /* Storage upload data */,
          enableAppleAndGooglePay /* enableAppleAndGooglePay */,
          customAudioPreviewURI /* customAudioPreviewURI */,
          custom VideoPreviewURI /* customVideoPreviewURI */,
          customArtworkURI /* customArtworkURI */
        )
          .then((result) => {
            // On deployment success
            deploymentSuccessFn(result);
          })
          .catch((error) => {
            // Failure
            deploymentFailureFn(error, “Asset deployment failed”);
          });
        }
    },
    // Handle failure
    (error) => {
      deploymentFailureFn(error, “Unable to complete transaction”);
    }
  );
}
```

The distribution microservice 24 which “backs” the content is designed such that it can be deployed and maintained by anyone/any service with non-transient computer or processor readable storage medium for storing the microservice processor executable code. These distribution microservices, which are a collection of services that interact with their respective smart contracts, we call a Decentralized Distribution Network. Decentralization is not achieved by enforcing that the content deployer run their own distribution service for the container, but rather by the fact that the container contract allows (only) the owner, preferably the content deployer, to update the contract to point to a different distribution service at any time with no impact to downstream consumers or vendors interacting with the contract program 28. Exemplary code for a distribution microservice such as a microservice 24, replete with explanatory comments, which verifies user/requester identity using cryptographic signatures and verifies access policy adherence by reading contract state on the blockchain is provided below:

In the select implementation above, specifically getGrantTimestampFromBridge, demonstrated is the issuance of a non-blockchain based access token to user/consumers by installing an opt-in encrypted token (cookie) onto a consumer device that is mapped to the contract state server side. This token is effectively an ephemeral decentralized identity. This method can be called “bridging”.

In one embodiment, a trusted application layer may pay the contract for the ability to sub-license the content to the user uniquely identified by the hardware based identity token, in exchange for consumer payment to the application for the service and associated sub-license. This transaction is atomic, e.g. the application is paid by the consumer and the contract is paid by the application, or the transaction does not complete. This method, which is an optional application specific layer of the larger distribution method disclosed, elides the requirement of the consumer using a digital wallet to transact with the content container contract.

Below, is exemplary code, replete with explanatory comments, that can be implemented as the deployment service 16 within the deployment server, the deployment server comprising non-transient computer or processor readable storage medium for storing deployment service executable code. The deployment server compiles the contract given the access policy configuration and content data and also spawns an embodiment of the distribution service 24 that is initially bound to the contract (though this server can be changed by the creator at any time). Effectively, this deployment server performs the containerization method.

```
server.addMethod(
  “deploy_pay_for_access_contract”,
  async ({
    owner_address,
    creator_address,
    metadata,
    price_per_access_usd,
    gas_to_complete_tx,
    gas_price_to_complete_tx,
    grant_ttl_seconds,
    rpc_endpoint,
    asset_ticker,
    share_identified_jwt,
  }) =>{
    const workflowId = makeWorkflowId( );
    const workflowIdLogger = logger.child({ workflowId });
    workflowldLogger.info(
      ‘deploy_pay_for_access_contract called with workflow_id: ${workflowId}’
    );
    workflowidLogger. info({
      owner_address,
      creator_address,
      metadata,
      price_per_access_usd,
      gas_to_complete_tx,
      gas_price_to_complete_tx,
      grant_ttl_seconds,
      rpc_endpoint,
      asset_ticker,
      share_identified_jwt,
    });
    server_lib.verifyIdentifiedJwt(
      share_identified_jwt /* token */,
      creator_address /* blockchain address */,
      GCP_PRIVATE_KEY /* server side private key dict */
    );
    const provider = makeProvider(rpc_endpoint);
    const web3 = new Web3(provider);
    const networkId = await web3.eth.net.getId( );
    await server_db.Accounts.commitWorkflow(
      workflowId,
      creator_address,
      networkId
    );
    workflowIdLogger.info(
      ‘Committed workflowId: ${workflowId}, creator_address: ${creator_address},
networkId: ${networkId}’
    );
    await server_db.Checkpoints.addCheckpoint(
      workflowId,
      checkpoint_consts.PROCESSES.DEPLOY_PFA,
      checkpoint_consts.DEPLOY_PFA_STATE.DEPLOYMENT_STARTED,
      {
        owner_address: server_db.makeFormattedAddress(owner_address),
        creator_address:
          server_db.makeFormattedAddress(creator_address),
        metadata,
        price_per_access_usd,
        gas_to_complete_tx,
        gas_price_to_complete_tx,
        grant_ttl_seconds,
        rpc_endpoint,
        asset_ticker,
        networkId,
      } /* metadata */
    );
    const buildDirectory = server_lib.makeBuildDirectory( );
    try {
      const costInfo = await getDeployPFACost({
        creator_address,
        price_per_access_usd,
        grant_ttl_seconds,
        rpc_endpoint,
        asset_ticker,
        share_unidentified_jwt: share_identified_jwt,
      });
      const costGasUnits = costInfo.total_cost_gas_units;
      const baseFee = await server_lib.getNetworkBaseFee(web3);
      const details = await server_db.Accounts.getDetails(
        creator_address,
        networkId
      );
      const balanceGwei = details.balance_gwei;
      const grossCostGwei =
        server_lib.grossContractDeploymentCostGwei(
          costGasUnits,
          gas_price_to_complete_tx,
          baseFee
        );
      workflowIdLogger.info(costInfo);
      workflowIdLogger.info(‘base fee: ${baseFee} wei’);
      workflowIdLogger.info(
        ‘deployment cost in gwei (including fees): ${grossCostGwei} gwei’
      );
      if (balanceGwei < grossCostGwei) {
        throw server_lib.makeServerError(
          ‘Insufficient funds. balance_gwei: ${balanceGwei} cost_gwei:
${grossCostGwei}’,
          { }
        );
      }
      workflowIdLogger.info(
        ‘balance ${balanceGwei} >= grossCostGwei ${grossCostGwei}’
      );
      workflowIdLogger.info(“deploying PFA...”);
      const accounts = await web3.eth.getAccounts( );
      const senderAddress = accounts[DEFAULT_ACCOUNT_INDEX];
      workflowIdLogger.info(“accounts:\n”);
      workflowIdLogger.info(accounts);
      workflowIdLogger.info(
        ‘\noperating as account: ${senderAddress}.\n’
      );
      workflowIdLogger.info(“building contract...”);
      await server_lib.buildContract(
        SHARE_GNFT_CONTRACT_CODE_PATH /* contractPath */,
        buildDirectory /* buildDirectory */,
        server_lib.getShareProtocolLibraryAddresses(
          networkId
        ) /* linkLibraries */
      );
      workflowIdLogger.info(“done.”);
      workflowIdLogger.info(“adding approved build hash...”);
      await server_lib.maybeAddApprovedBuildHash(
        web3 /* web3 */,
        senderAddress /* sender */,
        server_lib.getShareProtocolContractAddress(
          networkId
        ) /* contractAddress */,
        buildDirectory /* buildDirectory */,
        server_lib.getRuntimeBytecodeHash(
          “PFAUnit”,
          buildDirectory
        ) /* hash */,
        server_lib. CodeVerificationType
          .PFA_UNIT /* buildType (PFA_UNIT) */,
        “solc” /* compiler */,
        server_lib.getCompilerVersion( ) /* compilerVersion */,
        senderAddress /* authorAddress */,
        gas_to_complete_tx /* gas ToCompleteTx */,
        gas_price_to_complete_tx /* gasPriceToCompleteTx */
      );
      workflowIdLogger.info(“done.”);
      await server_db.Checkpoints.addCheckpoint(
        workflowId,
        checkpoint_consts.PROCESSES.DEPLOY_PFA,
        checkpoint_consts.DEPLOY_PFA_STATE.CONTRACT_BUILT,
        { } /* metadata */
      );
      workflowIdLogger.info(“deploying G-NFT...”);
      const receipt = await server_lib.deployGNFT(
        web3,
        senderAddress,
        gas_to_complete_tx,
        gas_price_to_complete_tx,
        buildDirectory
      );
      workflowIdLogger. info(‘done: ${JSON.stringify(receipt)}’);
      await server_db.Checkpoints.addCheckpoint(
        workflowId,
        checkpoint_consts.PROCESSES.DEPLOY_PFA,
        checkpoint_consts.DEPLOY_PFA_STATE.DEPLOYED_TO_BLOCKCHAIN,
        { receipt: JSON.stringify(receipt) } /* metadata */
      );
      const contractAddress = receipt.contractAddress;
      workflowIdLogger.info(“Calling cloud deploy...”);
      await server_lib.deployCloudFunction(
        ‘share-pfa-${server_lib.formatAddress(contractAddress)}’,
        server_lib.makeMetadataJsonPath(“./functions”),
        metadata,
        contractAddress
      );
      const safeContractAddress =
        server_lib.formatAddress(contractAddress);
      const cloudFunctionEndpoint = ‘${server_lib.makeCloudFunctionBaseURI(
        GCP_PRIVATE_KEY /* server side private key dict */
      )}/share-pfa-${safeContractAddress}’;
      await server_db Checkpoints.addCheckpoint(
        workflowId,
        checkpoint_consts.PROCESSES.DEPLOY_PFA,
        checkpoint_consts.DEPLOY_PFA_STATE.DEPLOYED_CLOUD_FUNCTION,
        { endpoint: cloudFunctionEndpoint } /* metadata */
      );
      workflowIdLogger.info(“Initializing G-NFT...”);
      const initializationReceipt = await server_lib.initializeGNFT(
        web3 /* web3 */,
        senderAddress /* senderAddress */,
        price_per_access_usd /* pricePerAccessUSD */,
        grant_ttl_seconds /* grantTTLSeconds */,
        asset_ticker /* assetTicker */,
        costInfo.initialize_cost +
          DEFAULT_TX_GAS_PADDING /* gas ToComplete Tx */,
        gas_price_to_complete_tx /* gasPrice ToCompleteTx */,
        contractAddress /* contractAddress */,
        cloudFunctionEndpoint /* tokenURI */,
        false /* supportsLicensing (default = false) */,
        0 /* licenseTTLSeconds */,
        server_lib.getShareProtocolContractAddress(
          networkId
        ) /* shareContractAddress */,
        buildDirectory /* buildDirectory */
      );
      workflowIdLogger.info(JSON.stringify(initializationReceipt));
      await server_db.Checkpoints.addCheckpoint(
        workflowId,
        checkpoint_consts.PROCESSES.DEPLOY_PFA,
        checkpoint_consts.DEPLOY_PFA_STATE. INITIALIZE_CONTRACT,
        {
          receipt: JSON.stringify(initializationReceipt),
        } /* metadata */
      );
      workflowIdLogger.info(“Setting G-NFT owner...”);
      await server_lib.setOwnerOnOwnable(
        web3,
        contractAddress,
        buildDirectory,
        senderAddress,
        owner_address,
        gas_to_complete_tx,
        gas_price_to_complete_tx
      );
      await server_db. Checkpoints.addCheckpoint(
        workflowId,
        checkpoint_consts.PROCESSES.DEPLOY_PFA,
        checkpoint_consts.DEPLOY_PFA_STATE.SET_CONTRACT_OWNER,
        { } /* metadata */
      );
      workflowIdLogger.info(“done.”);
      workflowIdLogger.info(“decrementing account balance.”);
      if (grossCostGwei < 0) {
        throw new Error(
          “A negative value has been supplied for either the max gas unit value or fee
configuration”
        );
      }
      await server_db.Accounts.incrementBalance(
        creator_address,
        networkId,
        −1 * grossCostGwei
      );
      await server_db.Checkpoints.addCheckpoint(
        workflowId,
        checkpoint_consts.PROCESSES.DEPLOY_PFA,
        checkpoint_consts.DEPLOY_PFA_STATE.DEPLOYMENT_COMPLETED,
        {
          contract_address: contractAddress,
          cloud_function_endpoint: cloudFunctionEndpoint,
          transaction_hash: receipt.transactionHash,
        } /* metadata */
      );
      // This is the final payload returned to the client via JSON RPC.
      return {
        contract_address: contractAddress,
        cloud_function_endpoint: cloudFunctionEndpoint,
        transaction_hash: receipt.transactionHash,
        workflow_id: workflowId,
      };
    } catch (e) {
      workflowIdLogger.error(e);
      await server_db.Checkpoints.addCheckpoint(
        workflowId,
        checkpoint_consts.PROCESSES.DEPLOY_PFA,
        checkpoint_consts.DEPLOY_PFA_STATE.DEPLOYMENT_FAILED,
        { error: JSON.stringify(e) } /* metadata */
      );
      // Since we logged the real error, send a generic error back to users.
      throw new Error(
        ‘Unable to complete contract deployment process. Error ID: ${workflowId}.
Please contact developers@formless.xyz and provide us with the Error ID to report
this issue.’
      );
    } finally {
      provider.engine.stop( );
    }
  }
);
```

### Analysis of Benefits

The benefits of the disclosed containerization and distribution method can be best understood by considering the number of properties onto which a piece of digital content may be legally distributed with perpetual royalty revenue flow to the content deployers of the digital content, the speed of the royalty revenue flow from consumer to /content deployer or whomever is designated in the smart contract code, and the boolean quantity of whether the access policy (price and term length) may be controlled by the contract owner using a single implementation which applies to all properties.

| No Containerization (e.g. | | Containerization using |
|---|---|---|
| distribution of data file to | | the principles disclosed |
| the vendor) | DRM | herein |
| Content may be distributed | DRM technology encoded | Content may be distributed |
| to an infinite number of | into the content must match | to an infinite number of |
| properties, however, legal | the interpretation code on a | properties using the |
| distribution onto those | per vendor basis. This | container contract address |
| properties with mechanical | means that the distribution | alone, while also |
| royalties associated with | rate is limited by per- | automatically transferring |
| that use is only possible | vendor DRM | royalty revenue flow to the |
| with a legal process and | implementation, and that | digital content owner(s). |
| accounting process | implementation is | Legal content use requires |
| between the digital content | completely vendor | no manual or intermediated |
| owner(s) and the | controlled. | access negotiation-the |
| distribution targets. | Number of properties is | terms of access are |
| This means the number is | linear O(N) with the number | encoded into the content |
| severely affected by the | of vendors that have | container itself. This is the |
| time it takes to negotiate | adopted the desired DRM | foundation of unlimited |
| legal use, and the time it | technology, however, DRM | scale. |
| takes to set up and | offers no solution for | Number of properties is |
| perpetually maintain proper | automated royalty | linear with the number of |
| accounting. Empirically, | accounting and therefore | vendors that can execute a |
| this number is on the order | the linearity is downgraded | function on a blockchain |
| of <10, e.g. only a handful | to constant-O(~10) with | smart contract. However, |
| of vendors have | the number of vendors that | due to the unique ability to |
| operationalized this | have adopted the selected | sub-license, a vendor (or |
| process, and each process | DRM technology and which | consumer) may legally host |
| is different. Revenue flow is | have operationalized a | containerized content from |
| an aggregate process that | process to distribute royalty | another vendor, effectively |
| occurs (most often) on a | revenues. A good example | creating a chain of |
| quarterly basis rather than | of one qualifying property | distribution network effects. |
| on an instantaneous | here is iTunes. | Due to this phenomena we |
| microtransaction level. | Speed of revenue flow | estimate that the number of |
| Number of properties is | is $/O(months). | properties onto which the |
| constant O(10) with the | Access policy control using | containerized content can |
| number of vendors that | a single implementation | be distributed is |
| have operationalized a | that applies to all properties | exponential, O(N\hat{ }2), since |
| process. | is 0. It may appear that this | any property may legally |
| Speed of revenue flow | is 1 due to DRM, but it is | sub-license containerized |
| is $/O(months). | not, since DRM is a vendor | content from any other |
| Access policy control using | controlled technology, e.g. | property. |
| a single implementation | the access policies are | Speed of revenue flow |
| that applies to all properties | dictated by the vendors | is $/O(seconds) since the |
| is 0. | which implement DRM, but | royalty accounting is done |
| | by the creative work owner | peer-to-peer on a |
| | (further illustrated in | blockchain. |
| | diagram below). | Access control using a |
| | | single implementation that |
| | | applies to all properties is |
| | | 1. |

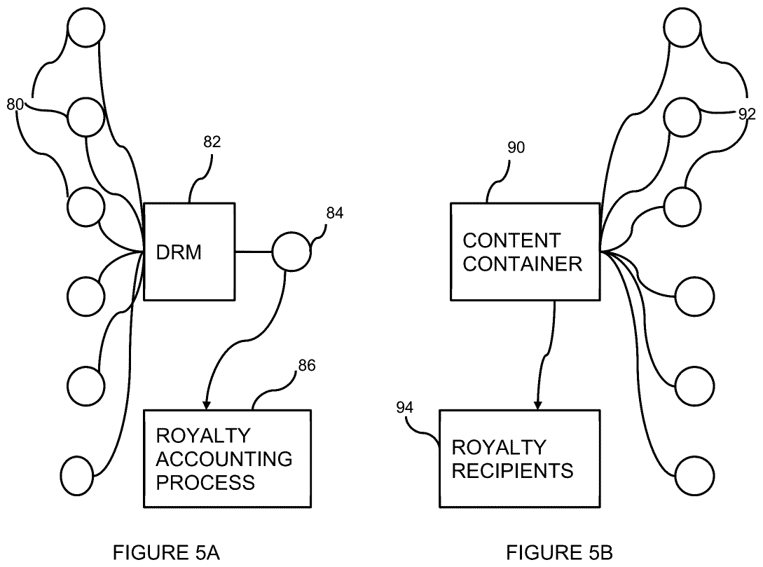

FIGS. 5a and 5b illustrate in a simple way the impact of the principles disclosed herein.

As illustrated in FIG. 5a, the DRM method is a “Many to 1” (N:1) distribution model, where many pieces of disparate content 80 are encoded using a single DRM technology 82 of a single vendor 84 and distributed to that vendor 84 which can interpret the encoding. Subsequently, the vendor 84 implements a royalty accounting process 86 to pay the digital content owner per some terms of service specified by the vendor. This is intermediation of a creator consumer value chain. In the DRM model each piece of content 80 is forced into a uniform access policy implementation which is dictated by a vendor 84. This severely limits distribution.

In contrast, as illustrated in FIG. 5b, the “access inversion” containerization method disclosed herein is “1 to Many” (1:N) distribution model, where, since the access policy code is executed in the container itself, all vendors with access to a blockchain node (where the container contract resides) may legally access the content by adhering to creator controlled terms codified within the container. Additionally, royalty accounting is done at the container level instantaneously on a given blockchain, and therefore does not need to be managed by an aggregate vendor controlled process. The number of distribution targets is unlimited and not gated by the ability to negotiate access terms or royalty accounting processes. As illustrated, any number of vendors 92 have access to the content container 90 (and its constituent components). The content container 90 renders payments directly to one or more royalty recipients 94 per the terms in the contract program.

Aspects of the technology disclosed herein may be used to protect and monetize all digital content, such as audio, video, photo and text. News article monetization could be a derivative application of this technology. Additionally, this technology can be used for companies to improve internal privacy standards. By handling inbound data in the proposed format, rather than arbitrarily structured strings and binary blobs, terms of service and other access considerations can be directly encoded into the data and self-maintained by the content owner.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

This detailed description has been presented for various purposes of illustration and description, but is not intended to be fully exhaustive and/or limited to this disclosure in various forms disclosed. Many modifications and variations in techniques and structures will be apparent to skilled artisans, without departing from a scope and spirit of this disclosure as set forth in various claims that follow. Accordingly, such modifications and variations are contemplated as being a part of this disclosure. A scope of this disclosure is defined by various claims, which include known equivalents and unforeseeable equivalents at a time of filing of this disclosure.

What is claimed is:

1. A non-transient processor readable storage medium containing processor executable instructions that when executed by the processor cause the processor to:
read a contract program storage to determine a state of a smart contract; and
render bytes of content to a user application when the state of the smart contract permits access to the content to the user application.

2. The non-transient processor readable storage medium of claim 1, wherein the instructions cause the processor to render previously selected bytes of the content to the user application when the state of the smart contract does not permit access to all of the content to the user application.

3. The non-transient processor readable storage medium of claim 1, wherein the processor executable instructions cause the processor to render the content to an endpoint having an IP address using the HTTPS protocol.

4. The non-transient processor readable storage medium of claim 3, wherein the processor executable instructions cause the processor to conditionally stream the content to an endpoint having an IP address using the HTTPS protocol.

5. The non-transient processor readable storage medium of claim 1, wherein the non-transient processor readable storage is not located on a blockchain.

6. The non-transient processor readable storage of claim 1, wherein the processor executable instructions cause the processor to render the content to an address provided by a token URI function or its equivalent.

7. The non-transient processor readable storage medium of claim 1, wherein the programming instructions comprise a distribution microservice.

8. The non-transient processor readable storage medium of claim 1, wherein the programming instructions are mutable.

9. The non-transient processor readable storage medium of claim 1, wherein the programming instructions cause the processor to decrypt the bytes of the content.

10. A non-transient processor readable storage medium of a blockchain network containing processor executable instructions that when executed by the processor cause the processor to:
control access to content using a smart contract program of a smart contract by establishing terms for access to the content and determine if a user application has complied with the terms;
store data indicating a state a smart contract; and
communicate with a distribution microservice via an API,
wherein,
the programming instructions comprise a container.

11. The non-transient processor readable storage medium of claim 10, wherein the container is addressable by an identifier of the blockchain and an address on the blockchain.

12. The non-transient processor readable storage medium of claim 11, wherein the programming instructions cause the API to communicate with a user application and the distribution microservice and to render bytes of the content to the user application.

13. The non-transient processor readable storage medium of claim 11, wherein the executable instructions initialize the API with data concerning:
a token URI function;
a price per access to the content; and
a total time to live for access to the content.

14. The non-transient processor readable storage medium of claim 10, wherein the executable instructions enable the distribution microservice to call for information as to when access to the content was granted and information as to when a license was granted to access the content.

15. The non-transient processor readable storage medium of claim 10, wherein the executable instructions enable a user application to:
obtain information as to a price to access the content;
obtain information as to a price for a license to use the content; and
retrieve an address to which the content is to be rendered.

16. The non-transient processor readable storage medium of claim 10, wherein the executable instructions enable the API to render the bytes of the content to a user application via a token URI function.

17. The non-transient processor readable storage medium of claim 10, wherein the contract program includes data establishing a price to access the content and a total time to live in which access to the content is open.

18. The non-transient processor readable storage medium of claim 15, wherein the contract program includes data establishing a price to access the content and a total time to live in which access to the content is open.

19. A content distribution system comprising:
a blockchain network;
a non-blockchain network;
a container stored on the blockchain network, the container being addressable by a blockchain network identifier and a blockchain address;
content stored on network addressable processor readable storage; and
a distribution microservice stored on a non-blockchain network,
wherein,
the container includes an API that contains an address of the distribution microservice,
the container includes an address for the content, and
the API is configured to communicate with the distribution microservice and a computer application to which the content is to be rendered.

20. The system of claim 19, wherein, the computer application is an intermediary application that can communicate between the API and a user application.

21. The system of claim 19, wherein the computer application is a user application.

22. The system of claim 19, wherein the API is initialized by the smart contract program with:
a token URI function;
a price per access to the content; and
a total time to live for access to the content.

23. The system of claim 22, wherein the API is configured to provide:
information as to a price to access the content;
information as to a price for a license to use the content; and
an address to which the content is to be rendered.

24. The system of claim 23, wherein the API renders the bytes of the data using the token URI function or its equivalent.

25. The system of claim 19, wherein the distribution microservice confirms an identity of the container using a signed message which uses a private key associated with the user.

26. A method comprising:
generating an access policy for content to be distributed over a computer network;
providing the access policy and content to a deployment service which is configured to provide (a) the content to a network accessible storage location, (b) the access policy to a complier which is configured to compile the access policy and an application programming interface into a container including a smart contract program and the application programming interface, and (c) a distribution microservice configured to interact with the container and determine a state of the smart contract program and render bytes of the content in accordance with the state of the smart contract program.

27. The method of claim 26, wherein the content is encrypted while stored.

28. The method of claim 27, wherein the distribution microservice decrypts the bytes of the content when rendered the bytes.

29. The method of claim 26, comprising storing the container on a blockchain network.

30. The method of claim 29, comprising storing the distribution microservice on a non-blockchain network.

31. The method of claim 30, wherein the container is accessed using a blockchain network identifier and an address on the blockchain by the distribution microservice and a user application.

32. The method of claim 26, wherein the container includes contract program storage with data indicating the state of the smart contract program.
